(19) United States
(12) Patent Application Publication
(10) Pub. No.: US 2015/0113504 A1
(43) Pub. Date: Apr. 23, 2015

(54) VIRTUAL HYBRID APPLICATION

(71) Applicants: SHAY ARTZI, BROOKLINE, MA (US); GAL STEINBERG, CHESTNUT HILL, MA (US)

(72) Inventors: SHAY ARTZI, BROOKLINE, MA (US); GAL STEINBERG, CHESTNUT HILL, MA (US)

(21) Appl. No.: 14/515,676

(22) Filed: Oct. 16, 2014

Related U.S. Application Data
(60) Provisional application No. 61/891,965, filed on Oct. 17, 2013.

(51) Int. Cl. G06F 9/44; H04L 29/08; G06F 9/445

(52) U.S. Cl. CPC G06F 8/70; G06F 8/65; H04L 67/10
USPC 717/120

(57) ABSTRACT

A mobile communication device that includes native and non-native capabilities has a single application platform, that is compatible with the operating system environment of the mobile communication device, and it has a plurality of instances of content that are created remotely from the mobile communication device and transmitted to the communication device over a network. The single application platform interacts with the operating system to control the operation of a native or non-native capability to display at least one of the plurality of instances of the content. A mobile communication device user enters commands into the communication device that when processed by the application platform allow the user to interact with the content.

### CROSS REFERENCE TO RELATED APPLICATIONS

This application claims the benefit under 35 U.S.C. §119(e) of U.S. Provisional Patent Application Ser. No. 61/891,965 entitled “VIRTUAL HYBRID APPLICATION”, filed Oct. 17, 2013, the entire contents of which is incorporated by reference.

### FIELD OF THE INVENTION

The present disclosure relates generally to the design of computer based hybrid applications and specifically to the design and operation of a virtual hybrid application.

### BACKGROUND

Computer applications can be designed to run on various types of computational devices that are designed to connect to a communications network either wirelessly or via a wired medium. Such applications can be designed to run on mobile communication devices such smart phones and tablets computers (typically termed mobile applications) or they can be designed to run on devices that are not easily transported from place to place, such as lap top or personal computers (typically terms applications), or they can be designed to run on both types of devices. Applications that are developed to be disseminated to a wide geographic area are typically stored on a server that is connected to a network, such as the Internet, where they are available to those who wish to load the application onto their communications device. Many computer applications are designed to allow users to easily access and/or interact with third party content. This third party content can include, but is not limited to, multimedia information such as images, video and music, it can include network addresses, geographic location information or other information made available by the 3rd party to the application user. Information of interest can include airline scheduling, flight availability and ticket reservation, hotel room information and reservations, etc.

One consideration when designing a computer application is identifying the type of functionality the application will be interacting with. Depending upon the type of device capability/feature a computer application is designed to interact with, the application can be referred to as either a native application, a Web-based application or a hybrid application. A native application is designed to interact with capability that is native to a device on which the application is running, such as a camera function, GPS, accelerometer, graphics, address book and other user interface functionality that is integral to the device and driven by the device operating system. Web-based applications are designed to interact with run browser functionality or to run HTML5 applications that are opened in a browser. Hybrid applications are typically Web-based applications that are wrapped inside a thin native container, and these applications are able to interact with both native and Web-based functionality, albeit in a less than optimal manner.

Another consideration when designing computer applications is determining what operating system the application will be compatible with. Typically each manufacturer designs their device to run under the control of a particular software operating system. Among other things, an operating system generally controls functionality that is native to the communications device in which it is running. Applications designed to be compatible with one operating system will not operate properly on a device designed to run under the control of a second, different operating system. So, for example, an application designed to be compatible with Apple Computer's iOS operating system will not run correctly on a device running under the control of Google's Android operating system.

Due to the difference in programming interfaces to each operating system and depending upon its operational complexity, developing an application can be a difficult and time consuming task. In order to expedite their development, software tools are commercially available to assist with the development of computer applications. These tools are referred to as software development kits or SDKs, and SDKs are available for developing computer applications so that they are compatible with most of the operating systems running on commercially available communication devices.

### BRIEF DESCRIPTION OF THE DRAWINGS

The present invention can be best understood by reading the specification with reference to the following figures, in which:

FIG. 1 is a diagram illustrating component parts that can comprise a Virtual, Hybrid Application Development and Deployment System 50.

FIG. 2 is a diagram showing functional element comprising a shared, hybrid application creation, editing and publishing module 200.

FIG. 3 is a diagram showing a first party user communication device having a virtual hybrid application platform.

FIG. 4 is a diagram showing the functional element comprising the virtual hybrid application platform.

FIG. 5 is a diagram showing the structure of an instance of a virtual hybrid application.

FIG. 6 is a diagram showing different categories of html files comprising an instance of a virtual hybrid application.

### DETAILED DESCRIPTION

While currently available software tools (SDKs) can greatly simplify the application development and deployment process, manufacturers of computational devices typically require that applications designed to run on their devices meet certain interoperation standards with respect to their operating environments (device operating systems). As such, these manufacturers typically require that before an application is made available to users, or before the manufacturer will certify whether the application is compatible with their operating environment, it is necessary for the application to be tested in the target operating environment by either the manufacturers test house or an independent testing organization certified by the manufacturer. This application certification process can take time and needlessly delay the deployment of newly developed applications. Further, in the event that a previously certified application is updated or modified in some respect, it is very often necessary to re-certify the updated version of the application before it can be distributed to users.

In light of the short comings exhibited by SDKs used to develop and deploy computer applications for operation on first party communication devices connected to a network, we have designed a virtual hybrid application platform (VHA Platform or Platform) that can be deployed on a plurality of geographically distributed communication devices that operates to support multiple instances of a third party virtual hybrid application (VHA). The Platform is certified to operate in at least one system operating environment, and modifications to the platform are made by and under the control of a single, second party organization. The VHA platform is designed to interact with a capability or feature that is native to the first party communication device and to interact with Web-based, or non-native feature, and in this regard can operate as a hybrid application/platform.

Each one of the multiple instances of a third party virtual hybrid application (VHA) can be developed and deployed using a shared, virtual hybrid application development and deployment console (Console). The Console can be located in any appropriate computational device (server for instance) which is configured to connect to a communication network and which is accessible over the network by a plurality of third party VHA developers. Each instance of a VHA is comprised of third party content, and different types of third party content implement different VHA functionality as experienced by a user of a communication device running the VHAs. This VHA functionality can be native or non-native to the device on which the VHA is running. The Console allows a third party VHA developer to create new applications and to update existing applications by merely creating and deploying their content to a user device. The Console allows third parties who have no experience with computer program languages to easily develop and to deploy their application content in a computer file that is immediately executable by the user's communication device without the need to compile the computer file.

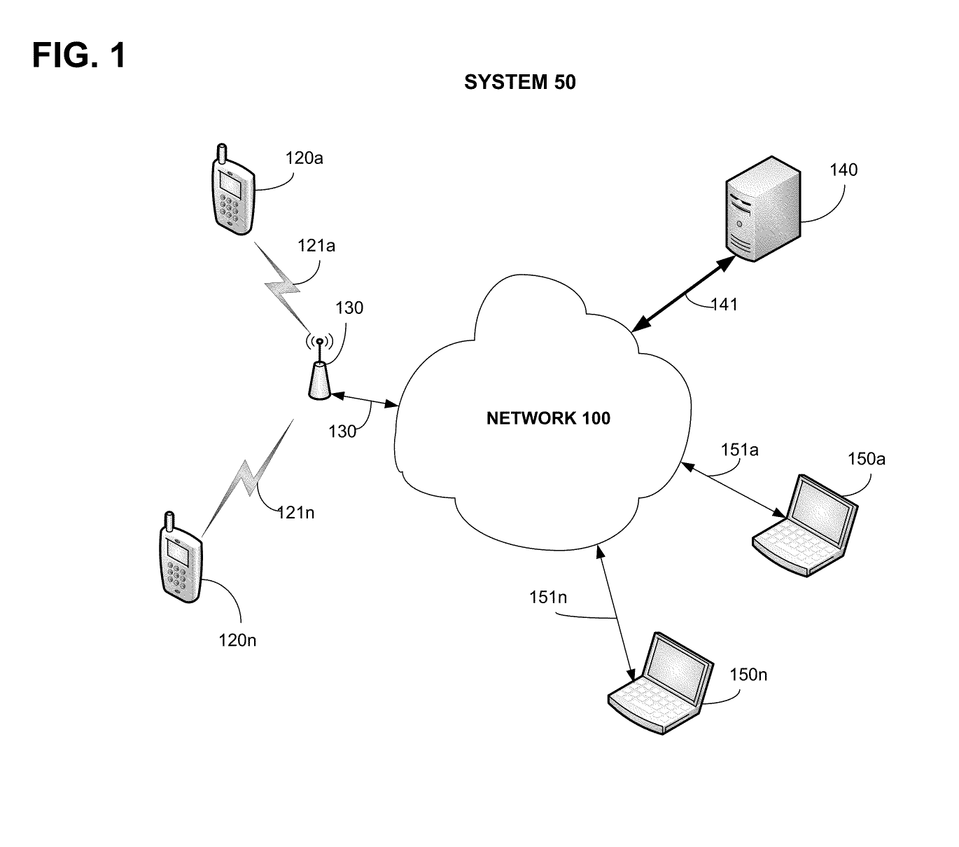

FIG. 1 generally illustrates component parts that can comprise a Virtual, Hybrid Application Development and Deployment System 50 (or simply the System 50). As shown in FIG. 1, the System 50 can have a communication network 100 that operates to support the transmission of information between a number of different types of communication devices connected to it. The network 100 can be the Internet, a public switched telephone network or a cellular network for instance, with each network operating according to an appropriate communication protocol. The network 100 can be comprised of one or more separate networks, each operating according to different communication protocols, or it can be a single, hybrid network supporting the operation of multiple different communication protocols. Connected to the network 100 in FIG. 1 are a plurality of 1st party user devices 120a-120n, with n being some integer, at least one computational device 140 configured to connect to the network 100, such as a network server, and a plurality of network computational devices 150a-150n (n being an integer value) under the control of a 3rd party content provider or any 3rd party organization offering products or services. The user devices can be mobile, wireless communication devices, such as a smart phone or a tablet computer, they can be communication devices that are not easily transported from place to place such as a personal computer or laptop computer, or they can be combination of both mobile and stationary devices. Regardless, these devices 120a-120a are connected to a wireless infrastructure 130 over wireless links or channels 121a-121n respectively. Generally each of the user devices 120a-120n can be configured to support some or all of the communication protocols necessary to transmit and receive information over the Network 100, and they can have one or more native features that are integral to a user device and controlled by the device's operating system. Such native features can include, but are not limited to, a contact list and calendar stored on the device, ringtones that can be played by the device, display control settings, accelerometer, camera, audio/video capture, SMS transmission, geo-location and access to media.

Continuing to refer to FIG. 1, the server 140 is connected to the network 100 over a link 141, which can be any type of appropriate wired or wireless link. The server 140 can be any generally available computational device comprising a processor and non-volatile, computer readable memory with a network interface suitable for transmitting information to and receiving information from the network 100, and capable of supporting, according to an embodiment of the invention, a shared, virtual hybrid application content creation, editing and publishing module which is referred to hereinafter as a 2nd party console or simply the console. Although FIG. 1 only includes one server 140, more than one server having substantially the same functionality can be included in the system 50.

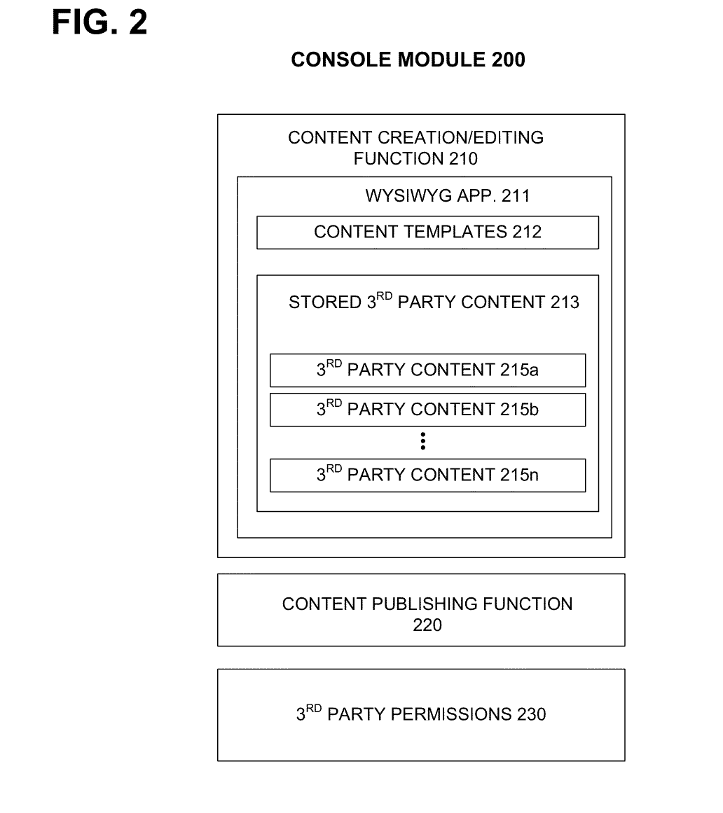

Each of the plurality of content provider devices 150a-150n are connected to the network 100 over respective links 151a-151n and are configured in a manner that permits a content provider to interact with the console on the server 140. Specifically, a content provider is able to connect over the network 100 with the server 140 in order to access the functionality provided by the console in order to create and edit content associated with their business, and then to publish the content over the network 100 to user devices which may either subscribe to the content or which may be interested in the content. Content in this context can include, but is not limited to, forms or applications germane to the content providers business, a listing of products or services offered by the business, an interactive voice response (IVR) or visual interactive voice response (VIVR) menu, phone number or URL content, video or audio content, or any other type of information corresponding to the content providers business. The manner in which a content provider can interact with the console to create, edit and publish content is described below with reference to FIG. 2.

FIG. 2 shows the functional elements comprising a 2nd party console module 200 that can be included in the server 140. As described above, the system 50 can include more than one server 140 and each server has at least one instance of the console module 200, each instance of the module having substantially the same functionality as each other instance of a module. The console 200 running on the server 140 can be under the control of the 2nd party which can grant access to the console to multiple 3rd party content providers. The 3rd party content providers can be granted access to the console 200 on a subscription basis, for instance, and each of the subscribing 3rd party content providers can have access to some or all of the functionality comprising the console 200 depending upon need and subscription level. Generally, the console 200 in FIG. 2 has a content creation/editing function 210, a content publishing function 220 and a 3rd party permissions function 230. The content creation/editing function 210 allows a 3rd party contend provider to create new content or to edit existing content stored in association with the server 40. The 3rd party content can be created in any format that is appropriate to the type of content created. If the content is textual, then is can be created as a hypertext markup language (html) record, or if the content comprises one or more images, then the format can be JPEG. According to one embodiment, the function 210 can be implemented in the console as a WYSIWYG type application, but other functionality can be implemented to create the content, and the function 210 is not limited to only WYSIWYG type applications. The content publishing function 220 can be designed to operate to publish any type of content created by a third party to a number of interested end users (1st parties), and it can operate to permit end user subscribers to download content to their user device. Suitable publish/subscribe (pub/sub) functionality is well known to those familiar with network communication technology, and so will not be describe here further. The 3rd party permission function 230 can be any commercially available user authentication functionality that can use a digital certificate or some other means for verifying a 3rd party's identify.

As previously described, the content creation/editing function 210 allows a 3rd party content provider to author content in any standard format that, among other things, allows embedded scripting functions, and a WYSIWYG application 211 comprising the function 210 can be employed by each 3rd party content provider to create content. Depending upon whether or not a user is expected to interact with 3rd part content and depending upon the type of interaction, 3rd party content can be created to be displayed in many different formats. Different content development tools 212 for each type of 3rd party content can be stored on the server 40 in association with the console 200, and one or more of these tools 212 can be selected by a 3rd party content provider to assist them with the creation and editing of their content. The tools 212 are created by the 2nd party using content creation and editing functionality that is appropriate to the content type, which for instance can be any well known markup language editor, such as an html editor. The tools available for use by a content provider in the content editor allow a 3rd party content provider with little or no experience in programming languages to easily create content. Alternatively, more sophisticated users can employ the same tools to create and edit more complex instances of content. In operation, when accessed by a 3rd party content provider, the WYSIWYG application 211 can prompt the 3rd party to select the type of content that they want to create, and once the content type is selected, the application 221 can operate to cause the 3rd party's computational device, 150a for instance, to display a tool, that is appropriate to the selected content type, in a browser running on the 3rd party's device. The 3rd party can then interact with the tool to add or to edit content as prompted by the tool. A tool can be in the form of a questionnaire/wizard that prompts the content provider to enter content by asking a single question or a series of questions, it can be in the form of an question tree, or any other format that allows a content provider to enter their content.

Scripting languages such as JavaScript have been developed that enable functionality to be embedded in an html file (such as 3rd party content) that a user can interact with while viewing the file in a web browser. The console editing function 210 includes pre-programmed modules that a 3rd party content provider can select from in order to embed functionality in their content. Once the content is opened in a browser, an end user is able to add information to the content (such as completing a form or questionnaire) or they can invoke native or non-native capability on their communication device by selecting a scripted field (i.e., an icon or some other image that represents scripted functionality) in the content that represents native or non-native capability. Once selected, the user is able to control their device to initiate an action. An appropriate scripting editor can be any commercially available interpreted computer programming language tool, such as a JavaScript development tool.

Once content is created by a 3rd party, this content can be stored on the server 140 and is associated with and only accessible by (according to the permission function 230) the 3rd party content provider that created it. Separate stores of the content created by each 3rd party provider are represented in FIG. 2 as 3rd party content 215a-215n, with n being an integer value. Subsequent to creating new content or editing existing content, this content can be either stored for later publication or it can be immediately published to interested 1st party users. As will be described later, the content published to 1st party or end user devices is immediately/directly executable by the user's communication device without the need to compile or alter the content in any manner. In this manner, 3rd party content can be very rapidly disseminated to a large number of geographically distributed users and it can be immediately available to be viewed and interacted with by an end user.

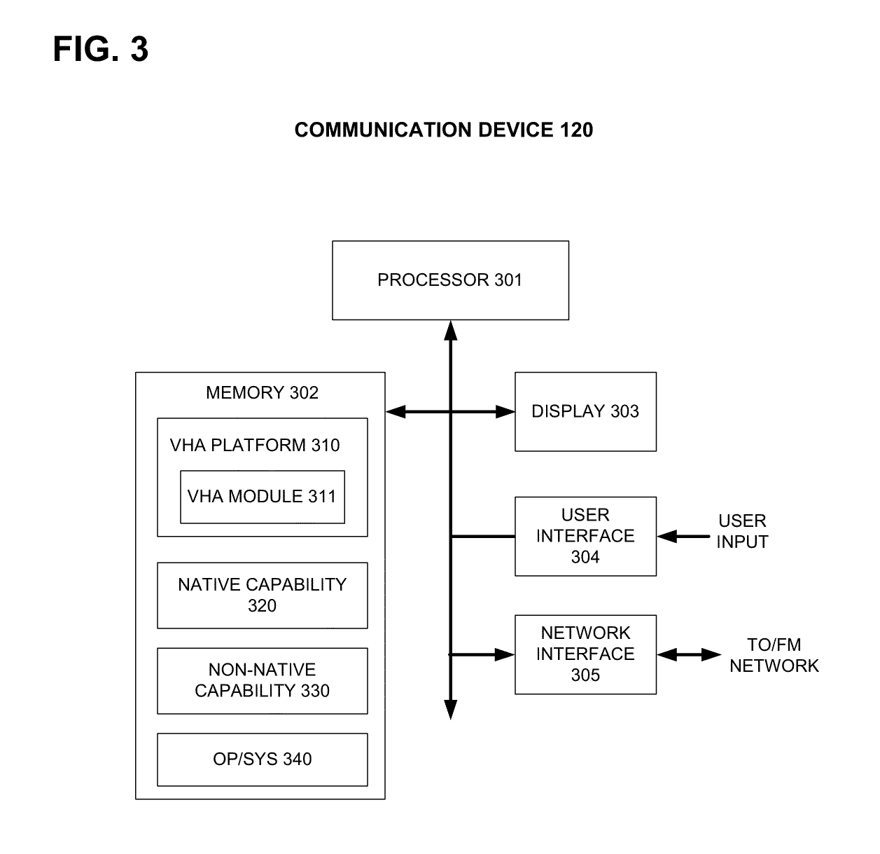

Upon publication of an instance of 3rd party content, the content information is transmitted by the console 200 over the network 100 (as dictated by publication instructions generated by the 3rd party content provider) to one or more of the end user communication devices, collectively referred to in FIG. 3 as end user communication device 120, for storage in a non-volatile, computer readable memory 302 illustrated with reference to FIG. 3. Generally, each end user's communication device 120 can include native and non-native features or capabilities, but from a functional perspective, each communication device 120 is comprised of a processor 301, non-volatile computer readable memory 302, a display 303, one or more user interfaces 304, and one or more interfaces 305 with the network 100. Among other things, stored in the memory 302 of the communication device 120 shown in FIG. 3 is computer code (operation system 340) that is comprised of instructions that when operated on by the processor 302 cause the device 120 to control the operation a virtual hybrid application platform 310, to control the operation of one or more native capabilities 320, and to control the operation of one or more non-native capabilities 330. Each of the platform 310, the native and non-native capabilities 320 and 330 respectively are implemented in computer readable code comprised of instructions that are compatible with the operating environment of the user's communication device 120.

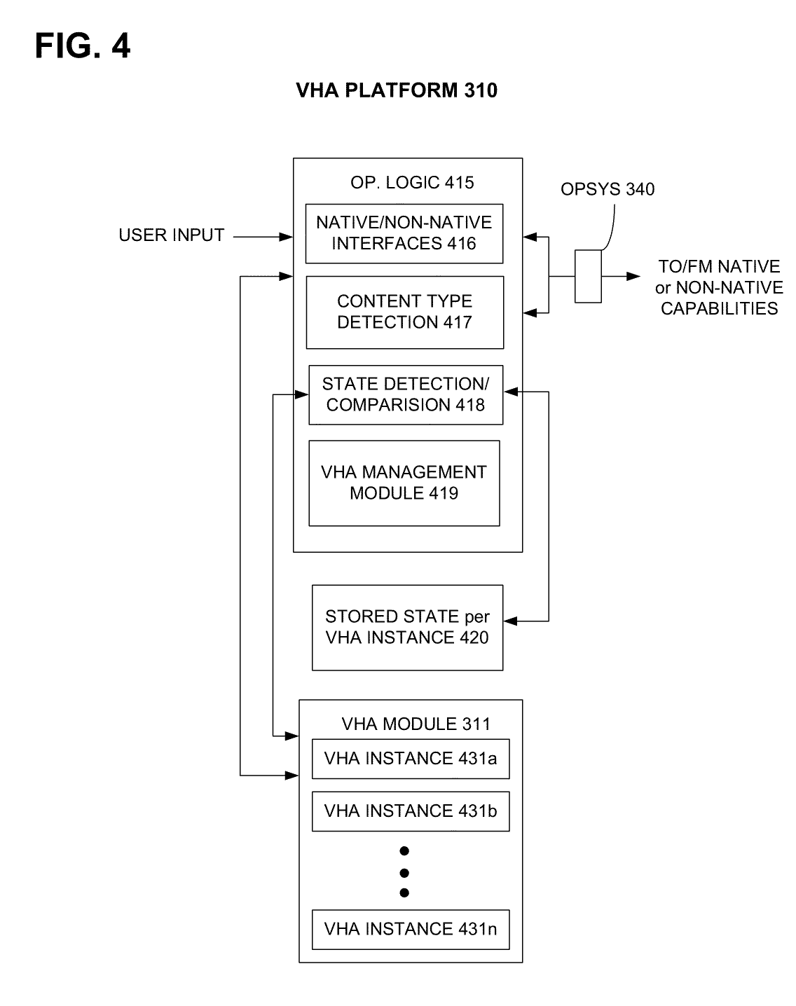

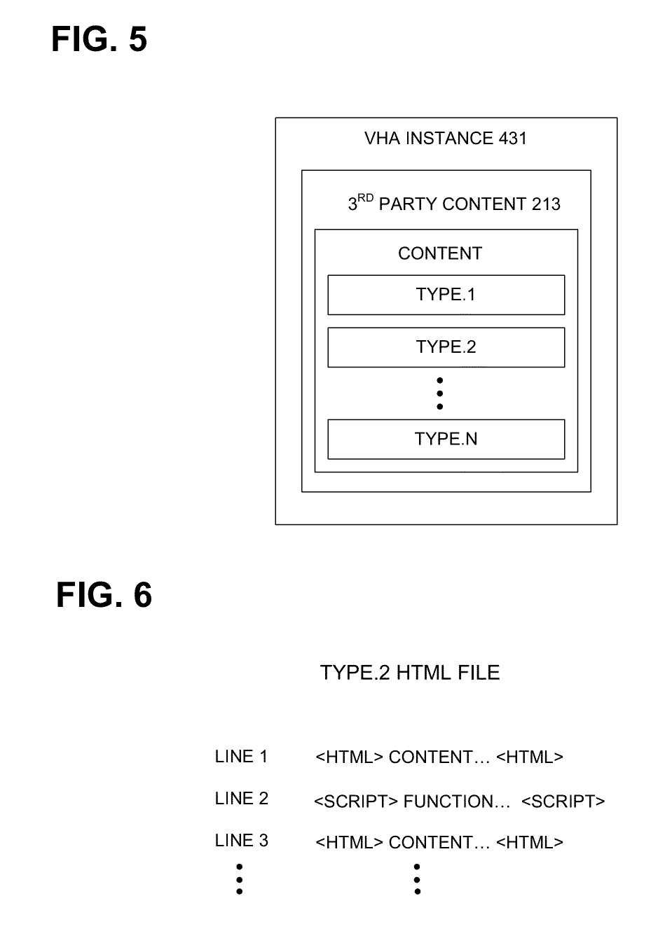

The virtual hybrid application platform (VHA platform) 310 is designed to support the operation of multiple instances of a virtual hybrid application (VHA) 311. In one embodiment, one or more instances of a VHA stored in module 311 can be displayed to a device 120 user as an icon, within the VHA platform 310, that distinctively identifies either the source of the content (content provider) or the type of content. In another embodiment, one or more instances of a VHA can be displayed outside the VHA platform 310, such as on a desktop or dash board, for instance. In the event that a VHA instance is displayed on a dash board, it can have information that is a pointer to a location in memory 302 where the associated content is stored. The platform 310 is designed to interact with the native capabilities 320 and the non-native capabilities 330 configured to run on the device 120, and the platform 310 is designed to interact with each instance of a virtual hybrid application (VHA) to allow the device 120 user to view and interact with 3rd party content comprising each VHA. The structure of each instance of a VHA is described later with reference to FIG. 5. As the platform 310 is able to interact with both native and non-native communication device features, it can be viewed as having hybrid application functionality. The functional elements comprising the VHA platform 310 are described below with reference to FIG. 4.

The VHA Platform 310 has a number of component parts, each of which are implemented in computer readable code stored in memory associated with a user's communication device, such as the communication device 120 in FIG. 3. Operating logic 415 is comprised of instructions that when operated on by the processor 301 cause the Platform 310 to respond to user input to, among other things, indirectly control the operation of native and non-native capabilities running on the communication device 120, to manage the storage, maintenance and operation of each instance of a plurality of VHAs 431a-431n (with n being an integer value) comprising the VHA module 311, and to detect current VHA state, to compare current state to past state and to intervene in a user process depending upon a relationship between previously stored VHA state and currently detected VHA state.

Each instance of a VHA 431a-431n that is stored in association with the VHA module 311 and can be comprised of a nested hierarchy of content corresponding to one particular 3rd party content provider. As previously described, this content is deployed/published to selected user communication devices by 3rd party content providers in a content message. Each selected user communication device receives the content message, and this message with the associated content (content file) is passed to a VHA management module 419 associated with the operating logic 415 running on the Platform 310. The VHA management module detects which particular 3rd party has published the content message and stores the content associated with the message in a particular VHA instance corresponding to the publishing 3rd party. The VHA management module can be implemented in any appropriate database management system, and can operate to store new 3rd party content and to update earlier versions of 3rd content that are stored in association with each VHA instance.

Returning to the operating logic 415, this logic can examine each VHA instance 431a-431n (referred to here collectively as VHA 431) in order to detect the type or types of 3rd party content comprising the VHA, and depending upon the type of content detected, the logic 415 can control capability (either native or non-native) on a user's communication device to perform an appropriate action in relation to the content. Among other things, this action can be to simply display the content, allow a user to edit the content, the action can be to initiate a phone call or internet session, or the action can be to play the content. Each VHA instance stored in the VHA module 311 can be presented in the form of an icon on the display of a user's communication device, and when a user selects/opens the icon, at least some content stored in association with the VHA instance can be viewed by the user on their device display. Depending upon the type of content that is displayed, the logic 415 can either wait for a user to interact with the content before taking any action, or after detecting that the user has selected a content type, it can generate an instruction that causes the user's device to control the operation of either a native or a non-native capability to display another layer of content, or to initiate a communication session with a remote communication device such as a legacy or IP phone or with a network server under the control of the 3rd party content provider. Depending upon the type of content selected by a user, the logic 415 can operate to cause the user's communication device to use either native or non-native capability to display another layer of content, initiate a communication session, allow the user to edit the content, play the content, or take any other action dictated by the type of content selected by the user at that time.

The operating logic 415 is comprised of several logical operating modules. It has a native/non-native capability interface module 416, a content type detection module 417, a VHA state detection/comparison module 418, and a VHA management module 419. As described earlier, the logic 415 can operate to open the content in a browser, if this is appropriate, and the user can interact with the content displayed by the browser in a manner that causes the platform to invoke a native capability (camera, calendar, contact list, etc.). For example, the user can select a function programmed into the content that causes the platform to attach a video or picture to the content, or to play music, or the user can select a phone number in the content which causes the platform to control the user's device phone capability to make a call. Or content can be selected that causes the user's device to initiate an internet session to connect with some URL to display remote content.

In operation, a user can select an icon on their communication device screen that is associated with a VHA instance 431, and the content detector 417 associated with the logic 415 determines what user device capability should be invoked to act upon the selected content. In the event that the end user selects a VHA instance in which the first level of content is text, then the detector logic 417 causes a web browser to simply display the text on the user's device display screen. Once the first level of content is displayed, the user may have the option to select some portion of the displayed content (select a field in the content) that is detected by the logic 417 and causes some other user device capability to be invoked, such as initiating a communication session, or copying an image into the first level of content. If the user selects a VHA instance in which the first level of content is something other than plain text, then some other user device capability is invoke to act upon this content (play audio, display an image, etc.).

Continuing to refer to FIG. 4, the state detector module 418 running in association with the operating logic 415 periodically or continually monitors the current state of each VHA instance 431 and passes this VHA state to module 420 which operates to store this state. A number of different VHA states can be detected by the logic 418, such as whether a particular VHA instance is active or not. Whether a user has selected or edited content associated with the VHA, and whether and how a communication session is started during the time a VHA instance is active. According to one embodiment, the platform 310 can operate to assist a user with their use of a VHA instance. In this regard, the VHA state detected and saved during a first time a VHA instance is active can be used to assist the user with their use of the VHA a second time the VHA instance is active. Specifically, if during the first time (or during repeated times) the VHA is active, the logic 418 detects that the user selects particular content associated with the VHA (selects one airline for instance), then the next time the user selects the VHA instance, the platform 310 can immediately display the content of interest to the user without the user needing to manually select the content that is of interest. The platform 310 can automatically select that content which is has previously determined the user is most likely to be interested in, without the need for the user to manually select each lower level/layer of content in order to navigate to the level or layer of content that they are interested in. For instance, if the user is interested in making a reservation on a particular airline, they could manually select each layer of content until they navigated to the layer that displays airline schedules. According to an embodiment, once a first level of content is selected by the user, the selected content is detected by the logic 418, compared to content selected from that VHA instance during an earlier (or multiple earlier) active sessions, and the layer of the content that is most likely of interest to the user is then displayed. Among other things, the logic 418 detects phone numbers dialed by each instance of a VHA, is detects levels of nodes of a IVR or VIVR to which a user navigates, it detects IP sessions that were initiated and URLs that were connected to, it detects music that is played and images that are displayed. The structure of a VHA instance 431 is now described with reference to FIG. 5.

The general structure of each the plurality of instances of a VHA 431 are substantially the same. Each VHA instance has at least one separate instance of 3rd party content (content file) 500 that can be implemented in a standard html programming language format by, in this case, a 2nd party. As described earlier with reference to the console 200, the second party (console administrator) is in sole control over the general structure of each VHA instance and provides the programming tools necessary for a 3rd party content provider, that may not have any programming experience, to very easily create their content. Each of a plurality of the content instances, labeled type.1-type.n (with n being an integer value), comprise 3rd party content and, depending upon whether an end user can interact with the content or not, the files may or may not have functional script embedded in them. A type.1 instance of content can represent textual information that can only be viewed by the user and not interacted with. A type.2 instance of content can represent content that a user can both view and interact with, and so forth. Further, each content instance type can include instructions that cause the content to be displayed differently to the end user on their communication device. For example, content in a type 1 file can be displayed as simple, in-line text without any special structure, and type 2 content can be displayed in a tree structure, such as in a visual IVR.

FIG. 6 illustrates a Type.2 content file format. Three lines of code are shown, with the first line including content (text for instance) that is to be displayed by a web browser. The first line has is any type of content that a user is able to view but not interact with. A second line has functional content that a user is able to interact with in some manner, and a third line includes content that a user can view but not interact with. While only three lines of marked up content are shown in FIG. 6, many more lines or segments of content can be included. In this case, linel of the content can be some text, viewable by a user, that explains the purpose of the VHA instance, such as welcoming the user and explaining the content to them. The second line can be something that the user can select in order to control the VHA to display another layer of content, and the third line can represent the other layer of content.

Each VHA instance represents content only and does not comprise a stand-alone computer application that it able to interact with a communication device operating environment. Each VHA instance, while being directly executable by a user's communication device, only exhibits functionality that is apparent to a user when the VHA platform 310 interacts with it in some manner. A third party is able to use the console 200 to develop an instance of a VHA or to modify an existing instance of a VHA, and each instance of a VHA can have one or more different types of content, and the VHA platform 310 operates to detect the different types of content comprising each VHA instance and determine what user communication device capability is appropriate to perform some action with respect to the content.

We claim:

1. (canceled)

2. A method of developing and deploying a mobile computer application, comprising:
downloading a computer application platform to a mobile communication device, the computer application platform operating to interact with capabilities associated with the mobile communication device and operating to interact with an instance of content;
generating the instance of content using a content development tool running on a computational device that is remote to the mobile communication device, the content development tool applying formatting instructions and functional instructions to media information comprising the instance of content to control the display format and behavior of the media information entered into the content development tool; and
transmitting the instance of content over a network to the mobile communication device and storing the instance of content in association with the computer application platform to create the mobile computer application.

3. The method of claim 2, further comprising selecting the mobile computer application by a mobile communication device user which causes the computer application platform to operate on the stored instance of content to play the media information in an appropriate capability associated with the mobile communication device according to the formatting instructions and the functional instructions comprising the instance of content.

4. The method of claim 2, wherein the capabilities associated with the mobile communication device are one or more of a native and a non-native capability.

5. The method of claim 4, wherein the native capabilities are any one or more of a contact list, a calendar, ringtones, mobile communication device display control settings, an accelerometer, a camera, audio and video capture, SMS transmission, geo-location and access to media, and the non-native capabilities are web-based computer applications.

6. The method of claim 2, further comprising generating multiple instances of content using the content development tool, each instance of content having at least some media information that is different than another instance of content and the computer application platform operating to interact with each one of the multiple instances of content.

7. The method of claim 2, wherein the format in which the media information is displayed is text, audio, video, images or any combination of these media formats, and the functional instructions control the behavior of the media information such that the mobile communication device user is able to or not able to interact with the media information.

8. The method of claim 2, wherein the content development tool running on the computational device is in communication with the mobile communication device over a local or a wide area network.

9. The method of claim 2, further comprising the mobile communication device user interacting with the mobile computer application in a manner that causes the computer application platform to interact with at least one capability associated with the mobile communication device.

10. The method of claim 9, wherein the computer application platform maintains a store of state information corresponding to interactions the mobile communication device user has with the mobile computer application.

11. A method of updating a mobile computer application associated with a mobile communication device, comprising:
downloading a computer application platform to a mobile communication device, the computer application platform operating to interact with capabilities associated with the mobile communication device and operating to interact with an instance of content;
generating a first instance of content using a content development tool running on a computational device that is remote to the mobile communication device, the content development tool applying formatting instructions and functional instructions to media information comprising the first instance of content to control the display format and behavior of media information entered into the content development tool;
transmitting the first instance of content over a network to the mobile communication device, and storing the first instance of content in association with the computer application platform operating on the mobile communication device to create the mobile computer application;
generating a second instance of content using the content development tool running on a computational device that is remote to the mobile communication device, the content development tool applying formatting instructions and functional instructions to media information comprising the second instance of content to control the display format and behavior of the media information entered into the content development tool, the second instance of content has at least some media information that is different than the media information comprising the first instance of content; and
transmitting the second instance of content over the network to the mobile communication device and the computer application platform operating to update the mobile computer application with the second instance of content to create an updated mobile computer application.

12. The method of claim 11, further comprising selecting the updated mobile computer application by a mobile communication device user, and the computer application platform operating on the stored third instance of content to play the media information in an appropriate capability associated with the mobile communication device according to the formatting instructions and the functional instructions comprising the third instance of content.

13. The method of claim 11, wherein the capabilities associated with the mobile communication device are one or more of a native and a non-native capability.

14. The method of claim 13, wherein the native capabilities are any one or more of a contact list, a calendar, ringtones, mobile communication device display control settings, an accelerometer, a camera, audio and video capture, SMS transmission, geo-location and access to media, and the non-native capabilities are web-based computer applications.

15. The method of claim 11, further comprising generating multiple instances of content using the content development tool, each instance of content having at least some media information that is different than another instance of content and the computer application platform operating to interact with each one of the multiple instances of content.

16. The method of claim 11, wherein the format in which the media information is displayed is text, audio, video, a still image or any combination of these media formats, and the functional instructions control the behavior of the media information such that the mobile communication device user is able to or not able to interact with the media information.

17. The method of claim 11, wherein the content development tool running on the computational device is in communication with the mobile communication device over a local or a wide area network.

18. The method of claim 11, further comprising the mobile communication device user interacting with the mobile computer application in a manner that causes the computer application platform to interact with at least one capability associated with the mobile communication device.

19. The method of claim 18, wherein the computer application platform maintains a store of state information corresponding to interactions the mobile communication device user has with the mobile computer application.

20. A mobile computer application stored on a mobile communication device, comprising:
one or more instances of content having media information to which is applied formatting instructions and functional instructions, and
a computer application platform operating to interact with the media information, the formatting instruction and the functional instructions comprising at least one of the one or more instances of content to control the display format and behavior of the media information presented to a user of the mobile communication device.
